(19) United States
(12) Patent Application Publication
(10) Pub. No.: US 2008/0215629 A1
(43) Pub. Date: Sep. 4, 2008

(54) TRACK SHUFFLING SYSTEM AND METHOD

(76) Inventors: Leo Parker Dirac, Seattle, WA (US); Scott Moore, Seattle, WA (US); Kristopher J. Wolff, Poulsbo, WA (US)

Correspondence Address: HOLLAND & KNIGHT LLP, 10 ST. JAMES AVENUE, BOSTON, MA, 02116, US

(21) Appl. No.: 12/034,322

(22) Filed: Feb. 20, 2008

Related U.S. Application Data
(60) Provisional application No. 60/890,708, filed on Feb. 20, 2007.

(51) Int. Cl. G06F 17/30

(52) U.S. Cl. 707/104.1; 707/E17.009

(57) ABSTRACT

A method and computer program product for defining an active playlist of media tracks for rendering in a defined sequence. A portion of the media tracks defined in the active playlist are rendered. A shuffle command is received from a user concerning the active playlist. A non-rendered playlist is generated. The non-rendered playlist defines one or more non-rendered media tracks included within the active playlist and excludes one or more rendered media track included within the active playlist. A rendering sequence is defined for the non-rendered playlist.

### RELATED APPLICATION

This application claims the benefit of U.S. Provisional Patent Application Ser. No. 60/890,708, filed 20 Feb. 2007, the contents of which are herein incorporated by reference.

### TECHNICAL FIELD

This disclosure relates to playlists and, more particularly, to the shuffling of playlists.

### BACKGROUND

Media distribution systems (e.g., the Rhapsody™ service offered by RealNetworks, Inc. of Seattle, Wash.) distribute media content to client electronic devices (e.g., client computers and MP3 players) from e.g., data servers. A media distribution system may distribute media content by allowing a user to download media data files and/or receive and process media data streams (collectively referred to as tracks).

Media distribution systems may allow users to define playlists for rendering media content on client electronic devices.

### SUMMARY OF DISCLOSURE

In a first implementation, a method includes defining an active playlist of media tracks for rendering in a defined sequence. A portion of the media tracks defined in the active playlist are rendered. A shuffle command is received from a user concerning the active playlist. A non-rendered playlist is generated. The non-rendered playlist defines one or more non-rendered media tracks included within the active playlist and excludes one or more rendered media tracks included within the active playlist. A rendering sequence is defined for the non-rendered playlist.

One or more of the following features may also be included. One or more rendered tracks included within the active playlist may be identified. One or more non-rendered tracks included within the active playlist may be identified. The one or more rendered tracks included within the active playlist may be compared to the one or more non-rendered tracks included within the active playlist to identify one or more common tracks. The one or more common tracks may be removed from the one or more non-rendered tracks included within the active playlist, thus defining the non-rendered playlist.

Defining a rendering sequence for the non-rendered playlist may include selecting a first track for rendering from the non-rendered playlist. The first track may be rendered. The first track may be removed from the non-rendered playlist. A modified non-rendered playlist may be defined. A second track may be selected for rendering from the modified non-rendered playlist. A non-rendered track rendering sequence may be defined for two or more of the non-rendered tracks defined within the non-rendered playlist. The two or more non-rendered tracks may be rendered in accordance with the non-rendered track rendering sequence.

One or more supplemental tracks for adding to the non-rendered playlist may be defined. The one or more supplemental tracks may be compared to the one or more non-rendered tracks defined within the non-rendered playlist to identify one or more common tracks. The one or more common tracks may be removed from the one or more supplemental tracks, thus defining one or more non-common supplemental tracks. The one or more non-common supplemental tracks may be added to the non-rendered playlist.

The method may be executed, at least in part, on a server computer. The method may be executed, at least in part, on a client electronic device.

In another implementation, a computer program product resides on a computer readable medium that has a plurality of instructions stored on it. When executed by a processor, the instructions cause the processor to perform operations including defining an active playlist of media tracks for rendering in a defined sequence. A portion of the media tracks defined in the active playlist are rendered. A shuffle command is received from a user concerning the active playlist. A non-rendered playlist is generated. The non-rendered playlist defines one or more non-rendered media tracks included within the active playlist and excludes one or more rendered media tracks included within the active playlist. A rendering sequence is defined for the non-rendered playlist.

One or more of the following features may also be included. One or more rendered tracks included within the active playlist may be identified. One or more non-rendered tracks included within the active playlist may be identified. The one or more rendered tracks included within the active playlist may be compared to the one or more non-rendered tracks included within the active playlist to identify one or more common tracks. The one or more common tracks may be removed from the one or more non-rendered tracks included within the active playlist, thus defining the non-rendered playlist.

Defining a rendering sequence for the non-rendered playlist may include selecting a first track for rendering from the non-rendered playlist. The first track may be rendered. The first track may be removed from the non-rendered playlist. A modified non-rendered playlist may be defined. A second track may be selected for rendering from the modified non-rendered playlist. A non-rendered track rendering sequence may be defined for two or more of the non-rendered tracks defined within the non-rendered playlist. The two or more non-rendered tracks may be rendered in accordance with the non-rendered track rendering sequence.

One or more supplemental tracks for adding to the non-rendered playlist may be defined. The one or more supplemental tracks may be compared to the one or more non-rendered tracks defined within the non-rendered playlist to identify one or more common tracks. The one or more common tracks may be removed from the one or more supplemental tracks, thus defining one or more non-common supplemental tracks. The one or more non-common supplemental tracks may be added to the non-rendered playlist.

The computer program product may be executed, at least in part, on a server computer. The computer program product may be executed, at least in part, on a client electronic device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a playlist shuffling process and a media distribution system;

FIG. 2 is a diagrammatic view of a screen rendered by the media distribution system of FIG. 1;

FIG. 3 is a diagrammatic view of a screen rendered by the media distribution system of FIG. I;

FIG. 4 is a diagrammatic view of a screen rendered by the media distribution system of FIG. 1;

FIG. 5 is a diagrammatic view of a screen rendered by the media distribution system of FIG. 1;

FIG. 6 is a diagrammatic view of a screen rendered by the media distribution system of FIG. 1;

FIG. 7 is a flowchart of the playlist shuffling process of FIG. 1;

FIG. 8 is a diagrammatic view of a screen rendered by the media distribution system of FIG. 1; and

FIG. 9 is a diagrammatic view of a screen rendered by the media distribution system of FIG. 1.

### DETAILED DESCRIPTION OF THE PREFERRED EMBODIMENTS

### System Overview

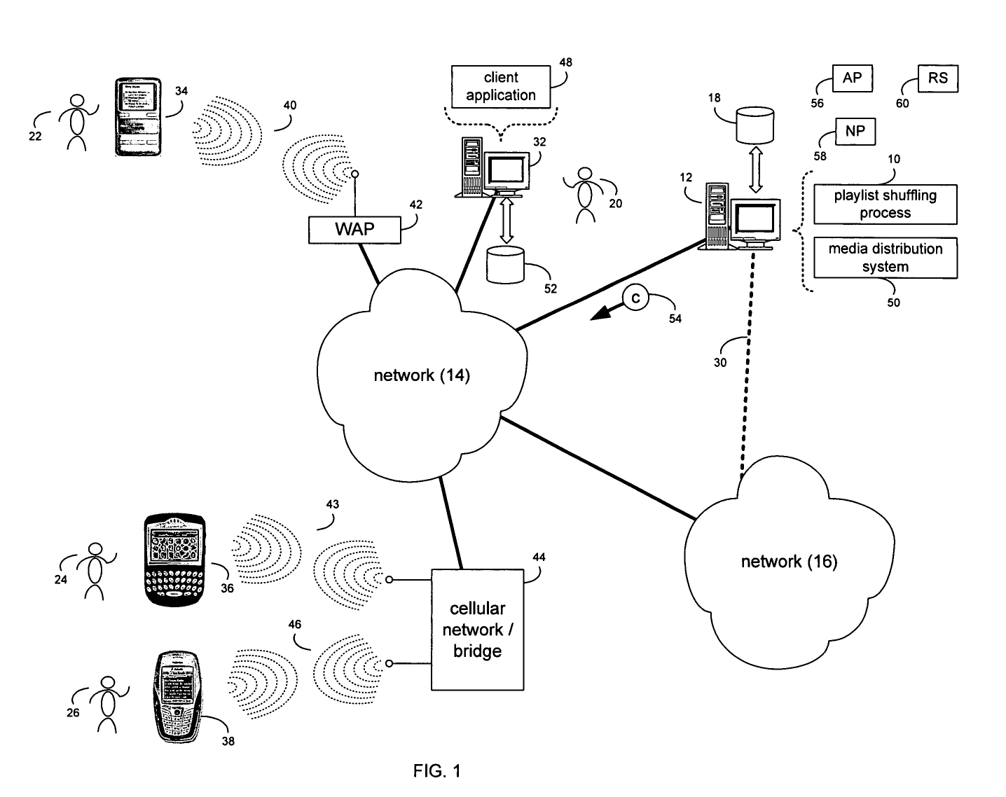

Referring to FIG. 1, there is shown a playlist shuffling process 10 that may reside on and may be executed by data server 12. As will be discussed below in greater detail, playlist shuffling process 10 may allow a user to shuffle a non-rendered portion of a playlist. A playlist defines a plurality of tracks that are to be rendered in a particular sequence.

Playlist shuffling process 10 may be a server application that may reside on and may be executed by data server 12, which may be coupled to network 14 (e.g., the Internet). Data server 12 may be a server (or series of servers) running a network operating system, examples of which may include but are not limited to: Microsoft Windows XP Server™; Novell Netware™; and Redhat Linux™, for example.

Data server 12 may also execute a web server application, examples of which may include but are not limited to: Microsoft IIS™, Novell Webserver™, or Apache Webserver™, that allows for HTTP (i.e., HyperText Transfer Protocol) access to data server 12 via network 14. Network 14 may be coupled to one or more secondary networks (e.g., network 16), examples of which may include but are not limited to: a local area network; a wide area network; or an intranet, for example.

The instruction sets and subroutines of playlist shuffling process 10, which may be stored on a storage device 18 coupled to data server 12, may be executed by one or more processors (not shown) and one or more memory architectures (not shown) incorporated into data server 12. Storage device 18 may include but is not limited to: a hard disk drive; a tape drive; an optical drive; a RAID array; a random access memory (RAM); or a read-only memory (ROM).

Users 20, 22, 24, 26 may access playlist shuffling process 10 directly through network 14 or through secondary network 16. Further, data server 12 (i.e., the computer that executes playlist shuffling process 10) may be connected to network 14 through secondary network 16, as illustrated with phantom link line 30.

Users 20, 22, 24, 26 may access playlist shuffling process 10 through various client electronic devices, examples of which may include but are not limited to client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown), for example.

The various client devices may be directly or indirectly coupled to network 14 (or network 16). For example, client computer 32 is shown directly coupled to network 14 via a hardwired network connection. Further, personal media device 34 is shown wirelessly coupled to network 14 via wireless communication channel 40 established between personal media device 34 and wireless access point (i.e., WAP) 42, which is shown directly coupled to network 14. WAP 42 may be, for example, an IEEE 802.11a, 802.11b, 802.11g, Wi-Fi, and/or Bluetooth device that is capable of establishing wireless communication channel 40 between personal media device 34 and WAP 42.

As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 14 via wireless communication channel 43 established between personal digital assistant 36 and cellular network / bridge 44, which is shown directly coupled to network 14. Further, cellular telephone 38 is shown wirelessly coupled to network 14 via wireless communication channel 46 established between cellular telephone 38 and cellular network / bridge 44.

Client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown), may each execute a client application (e.g., client application 48) that may interface with media distribution system 50. Media distribution system 50 may provide media data streams and/or media data files (i.e., collectively referred to as tracks) to a plurality of users (e.g., users 20, 22, 24, 26). Examples of media distribution system 50 may include, but are not limited to, the Rhapsody™ service and Rhapsody-To-Go™ service offered by RealNetworks, Inc. of Seattle, Wash.

Examples of client application 48 may include, but are not limited to, a web browser (e.g., Microsoft Internet Explorer™ and Mozilla FireFox™, for example), a stand alone application (e.g., Rhapsody™ client), an applet running within another program (e.g., Microsoft Internet Explorer™ and Mozilla FireFox™, for example), or any combination thereof. Client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown), may each execute an operating system, examples of which may include but are not limited to Microsoft Windows™, Microsoft Windows Mobile™, Redhat Linux™, or a custom operating system.

The instruction sets and subroutines of client application 48, which may be stored on a storage device (e.g., storage device 52) coupled to e.g., client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), or a portable gaming device (e.g., a Sony Playstation™ Portable, not shown), may be executed by one or more processors (not shown) and one or more memory architectures (not shown) incorporated into e.g., client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), or a portable gaming device (e.g., a Sony Playstation™ Portable, not shown). Storage device 52 may include but is not limited to a hard disk drive, a tape drive, an optical drive, a RAID array, a random access memory (RAM), a read-only memory (ROM), a compact flash (i.e., CF) memory, a secure digital (i.e., SD) memory, a trans flash memory, and/or a memory stick memory.

Media distribution system 50 may facilitate the transfer of media content 54 from data server 12 to the various client electronic devices (e.g., client computer 32, personal media device 34, personal digital assistant 36, cellular telephone 38, laptop computers (not shown), notebook computers (not shown), pagers (not shown), televisions (not shown), cable boxes (not shown), gaming devices (e.g., a Microsoft Xbox™, not shown), and portable gaming devices (e.g., a Sony Playstation™ Portable), for example).

The instruction sets and subroutines of media distribution system 50, which may be stored on storage device 18 coupled to data server 12, may be executed by one or more processors (not shown) and one or more memory architectures (not shown) incorporated into data server 12. As discussed above, storage device 18 may include but are not limited to a hard disk drive, a tape drive, an optical drive, a RAID array, a random access memory (RAM), or a read-only memory (ROM).

Media content 54 may be, for example, digitally-encoded audio and/or video data that is compressed using known compression techniques. Examples of such compression techniques may include, but are not limited to, MPEG1, MPEG2, MPEG4, H.263, H.264, Advanced Audio Coding, and other techniques promulgated by the international standards organization (ISO) and/or the Motion Picture Experts Group (MPEG).

Examples of media content 54 received from media distribution system 50 may include, but are not limited to: purchased downloads received from media distribution system 50 (i.e., media content licensed to e.g., user 20 for use in perpetuity); subscription downloads received from media distribution system 50 (i.e., media content licensed to e.g., user 20 for use while a valid subscription exists with media distribution system 50); and media content streamed from media distribution system 50, for example. Typically, when media content 54 is streamed from e.g., data server 12 to client computer 32, a copy of media content 54 is not permanently retained on client computer 32.

Examples of the types of media content 54 distributed by media distribution system 50 may include, but are not limited to: audio files (examples of which may include but are not limited to music files, audio news broadcasts, audio sports broadcasts, and audio recordings of books, for example); video files (examples of which may include but are not limited to video footage that does not include sound, for example); audio/video files (examples of which may include but are not limited to a/v news broadcasts, a/v sports broadcasts, feature-length movies and movie clips, music videos, and episodes of television shows, for example); and multimedia content (examples of which may include but are not limited to interactive presentations and slideshows, for example).

As will be discussed below in greater detail, using a client application (e.g., client application 48), users 20, 22, 24, 26 may acess media distribution system 50 and obtain media content 54 for rendering.

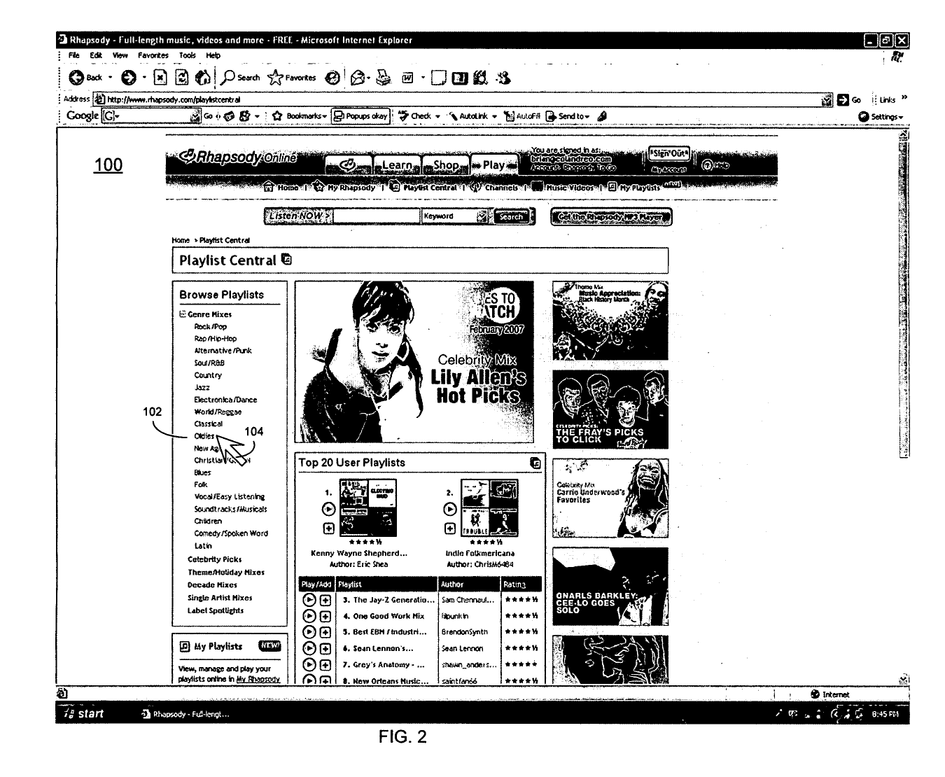

Referring also to FIG. 2, a user (e.g., user 20) may use a client application (e.g., client application 48) to access media distribution system 50 and obtain/render media content 54. As discussed above, examples of client application 48 may include, but are not limited to, a web browser (e.g., Microsoft Internet Explorer™ and Mozilla FireFox™, for example), a stand alone application (e.g., Rhapsody tm client), an applet running within another program (e.g., Microsoft Internet Explorer™ and Mozilla FireFox™, for example), or any combination thereof For example, user 20 may use client application 48 (e.g., a web browser) to visit the website www.rhapsody.com (e.g., webpage 100), which is provided by RealNetworks, Inc. of Seattle, Wash.

While browsing e.g., webpage 100 (which may be rendered by media distribution system 50), user 20 may review various playlists that are available for rendering. Webpage 100 may categorize playlists e.g., according to musical genres. For example, assuming that user 20 is an “Oldies” fan, user 20 may select “Oldies” link 102 using onscreen pointer 104, which may be controllable by a pointing device (e.g., a mouse, not shown).

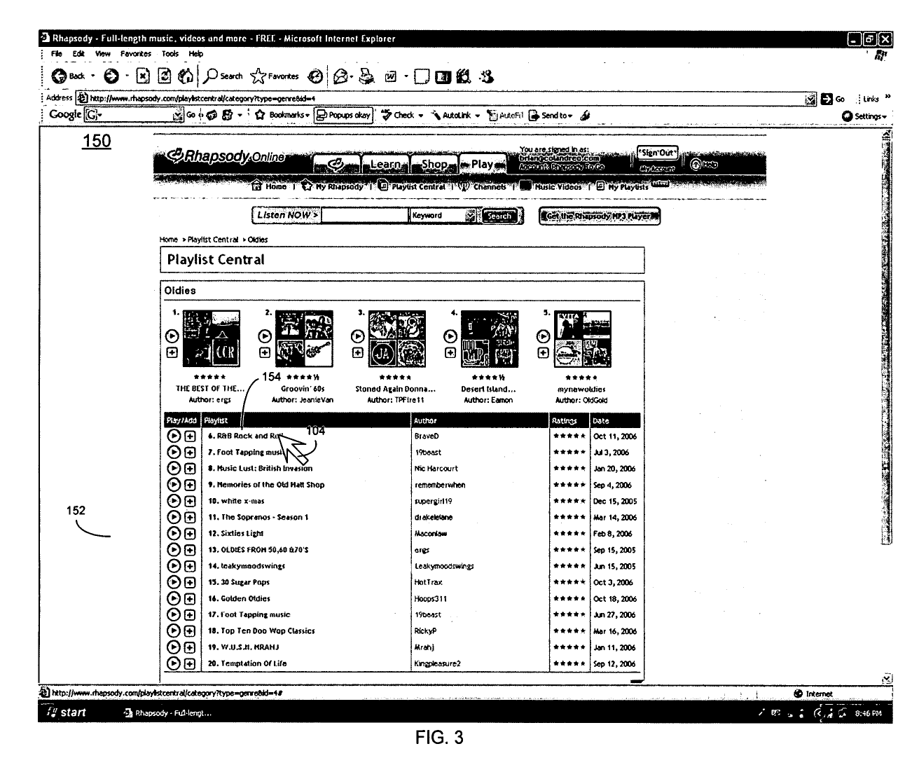

Upon selecting “Oldies” link 102 and referring also to FIG. 3, media distribution system 50 may render webpage 150, which may define a plurality 152 of “Oldies” playlists. Using onscreen pointer 104, user 20 may select a particular playlist for rendering (chosen from the plurality 152 of “Oldies” playlists). Assume for this example that user 20 selects “R&B Rock and Roll” playlist 154.

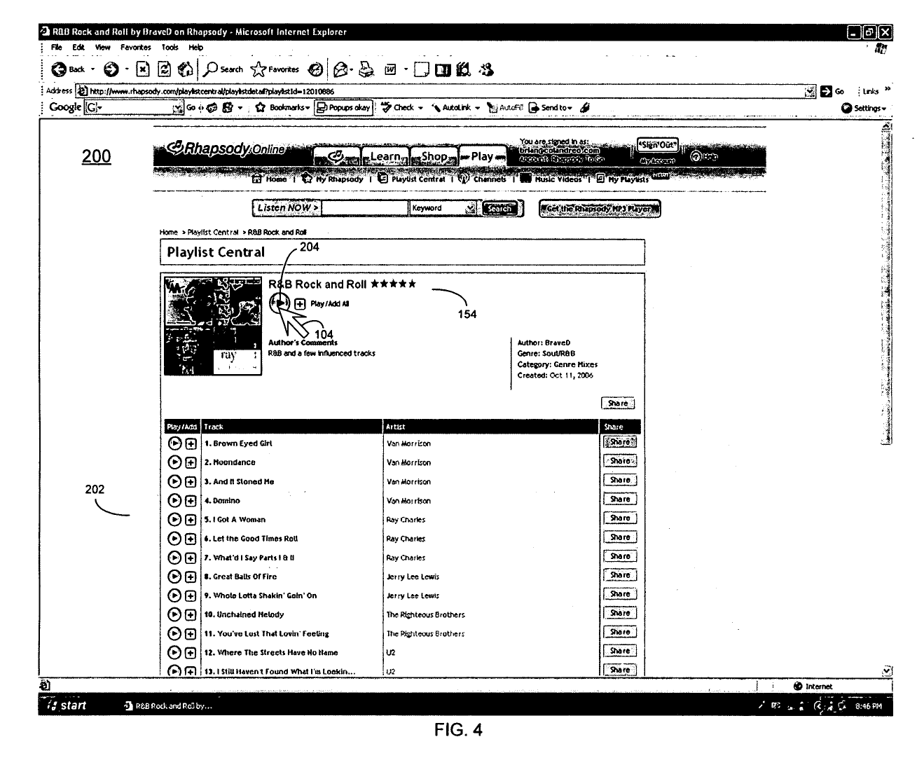

Referring also to FIG. 4, media distribution system 50 may render webpage 200, which may define a plurality of tracks 202 included within “R&B Rock and Roll” playlist 154. As discussed above, a playlist may define a plurality of tracks that are to be rendered in a particular sequence. Accordingly, “R&B Rock and Roll” playlist 154 is shown to define twenty-three tracks (thirteen of which are visible). Specifically, in this example, “R&B Rock and Roll” playlist 154 defines the following tracks for rendering in the following sequence:

| | | |
|---|---|---|
| 1. | Brown Eyed Girl | Van Morrison |
| 2. | Moondance | Van Morrison |
| 3. | And It Stoned Me | Van Morrison |
| 4. | Domino | Van Morrison |
| 5. | I Got A Woman | Ray Charles |
| 6. | Let the Good Times Roll | Ray Charles |
| 7. | What'd I Say Parts I & II | Ray Charles |
| 8. | Great Balls Of Fire | Jerry Lee Lewis |
| 9. | Whole Lotta Shakin' Goin' On | Jerry Lee Lewis |
| 10. | Unchained Melody | The Righteous |
| | | Brothers |
| 11. | You've Lost That Lovin' Feeling | The Righteous |
| | | Brothers |
| 12. | Where The Streets Have No Name | U2 |
| 13. | I Still Haven't Found What I'm | U2 |
| | Lookin . . . | |
| 14. | In God's Country | U2 |
| 15. | Don't Know Why | Norah Jones |
| 16. | Respect | Aretha Franklin |
| 17. | Johnny B. Goode | Chuck Berry |
| 18. | Maybelline | Chuck Berry |
| 19. | Tutti Frutti | Little Richard |
| 20. | Living In America | James Brown |
| 21. | I Got You (I Feel Good) | James Brown |
| 22. | What A Price | Fats Domino |
| 23. | Blue Monday | Fats Domino |

Assuming that user 20 finds “R&B Rock and Roll” playlist 154 to their liking, user 20 may select “play” button 204 using onscreen pointer 104. Once selected, a client application capable of rendering media content may be executed. As discussed above, examples of client application 48 may include, but are not limited to, a web browser (e.g., Microsoft Internet Explorer™ and Mozilla FireFox™, for example), a stand alone application (e.g., Rhapsody™ client), an applet running within another program (e.g., Microsoft Internet Explorer tm and Mozilla FireFox™, for example), or any combination thereof.

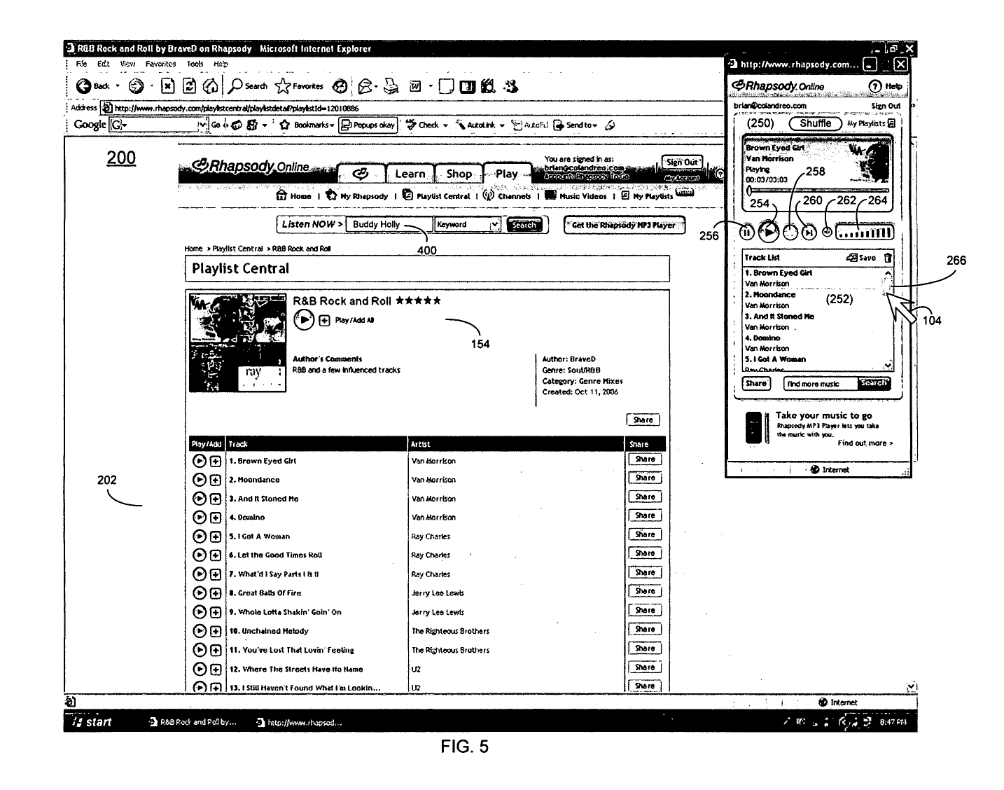

For this example and referring also to FIG. 5, assume that media distribution system 50 launches Rhapsody client 250, which may be executed (at least in part) on data server 12. Rhapsody client 250 may include an active playlist window 252 that displays active playlist 56 (FIG. 1) defined by playlist shuffling process 10. Active playlist window 252 may display the track currently being rendered (e.g., “Brown Eyed Girl” by Van Morrison), as well as the tracks that will be rendered in the future (e.g., “Moondance” by Van Morrison).

Using one or more controls included within Rhapsody client 250, user 20 may control the rendering of the various tracks included within “R&B Rock and Roll” playlist 154. For example, “play” button 254 may allow user 20 to start rendering the tracks included within “R&B Rock and Roll” playlist 154. “Pause” button 256 may allow user 20 to pause the rendering of the tracks included within “R&B Rock and Roll” playlist 154. “Skip Backward” button 258 may allow user 20 to skip backward to the previous track included within “R&B Rock and Roll” playlist 154 and “Skip Forward” button 260 may allow user 20 to skip forward to the next track to be rendered in “R&B Rock and Roll” playlist 154. “Mute” button 262 may allow user 20 to mute the audio playback of the tracks included within “R&B Rock and Roll” playlist 154 and “volume control” 264 may allow user 20 to adjust the volume of the audio playback of the tracks included within “R&B Rock and Roll” playlist 154. Further, scroll bar 266 within active playlist window 252 may allow the user to scroll (using onscreen pointer 104) through the list of tracks included within “R&B Rock and Roll” playlist 154.

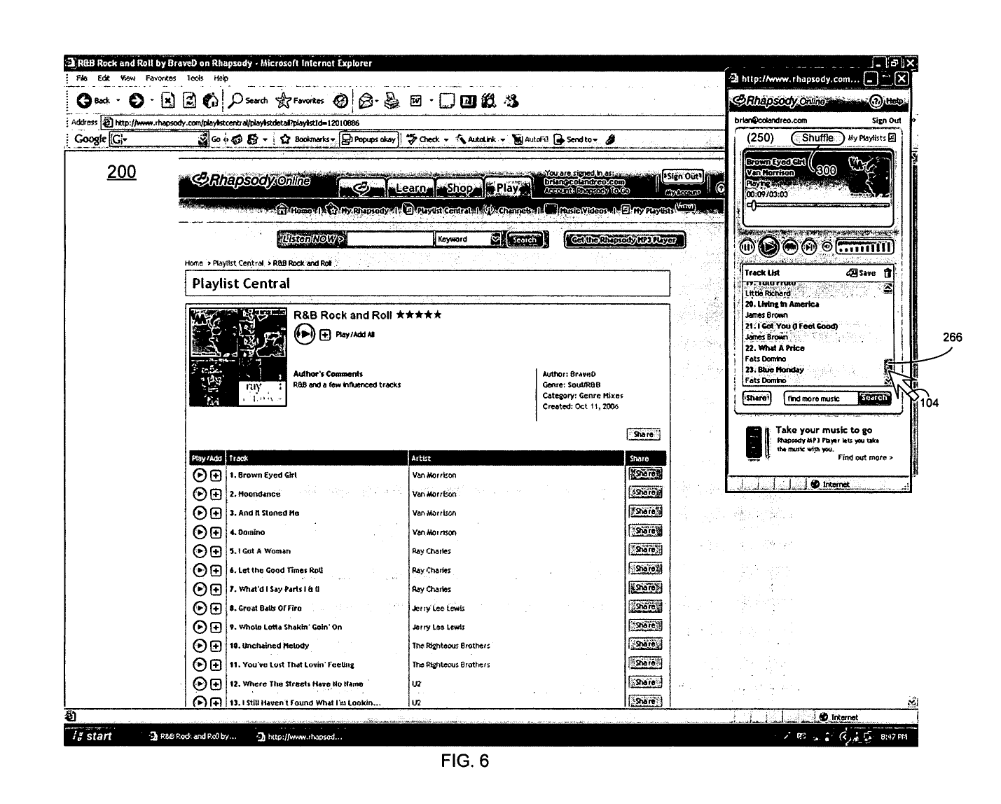

For example and referring also to FIG. 6, using onscreen pointer 104, user 20 may “drag” scroll bar 266 downward to review the tracks to be rendered to the end of “R&B Rock and Roll” playlist 154. As discussed above, a playlist may define a plurality of tracks that are to be rendered in a particular sequence. In this particular example, “R&B Rock and Roll” playlist 154 is shown to include twenty-three tracks. Accordingly and assuming that user 20 does not intervene, Rhapsody client 250 may continue to sequentially render each of the tracks defined within “R&B Rock and Roll” playlist 154.

Assume for illustrative purposes that: the first fourteen tracks of “R&B Rock and Roll” playlist 154 were completely rendered (illustrated below as struck through text); the fifteenth track (i.e., “Don't Know Why” by Norah Jones) of “R&B Rock and Roll” playlist 154 is currently being rendered (illustrated below as bold italicized text); and the last eight tracks of “R&B Rock and Roll” playlist 154 have not yet been rendered (illustrated below as underlined text). Accordingly, the current status of “R&B Rock and Roll” playlist 154 may be defined as follows:

| | |
|---|---|
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| | [symbol] |
| [symbol] | [symbol] |
| | [symbol] |
| [symbol] | [symbol] |
| [symbol] | [symbol] |
| [symbol] | [symbol] |
| [symbol] | [symbol] |
| 16. Respect | Aretha Franklin |
| 17. Johnny B. Goode | Chuck Berry |
| 18. Maybelline | Chuck Berry |
| 19. Tutti Frutti | Little Richard |
| 20. Living In America | James Brown |
| 21. I Got You (I Feel Good) | James Brown |
| 22. What A Price | Fats Domino |
| 23. Blue Monday | Fats Domino |

If user 20 wishes to vary the rendering sequence of “R&B Rock and Roll” playlist 154, user 20 may select “Shuffle” button 300 using onscreen pointer 104. The Playlist Shuffling Process:

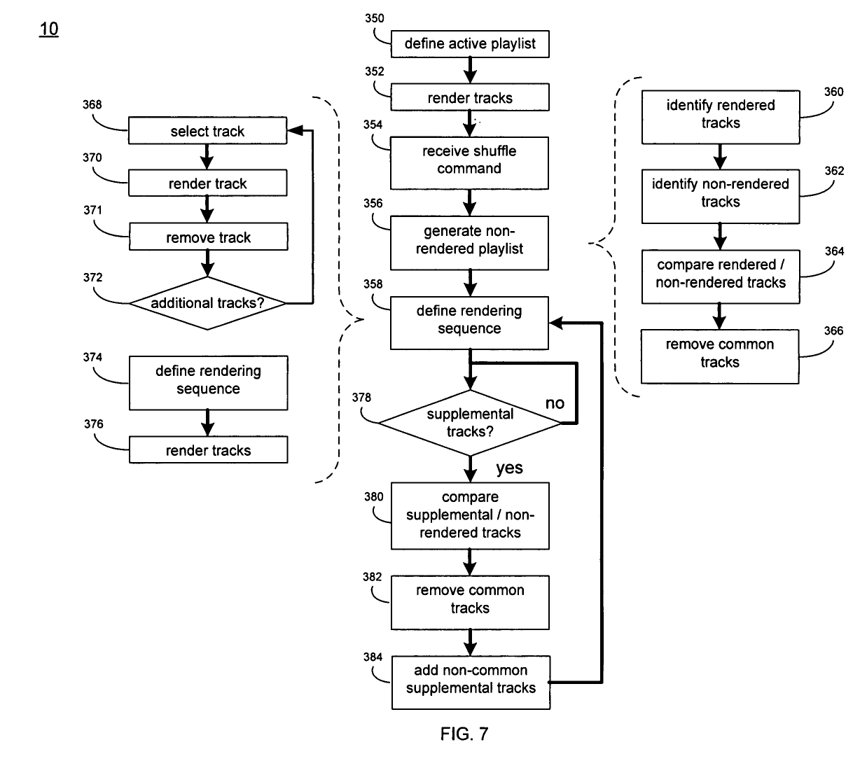

As discussed above, playlist shuffling process 10 may allow user 20 to shuffle the non-rendered portion of active playlist 56. For example and referring also to FIG. 7, process 10 may define 350 the active playlist 56 of media tracks as (in this example) the twenty-three tracks defined within “R&B Rock and Roll” playlist 154. Further and as discussed above, assume that the first fourteen tracks of “R&B Rock and Roll” playlist 154 have been rendered 352, the fifteenth track of “R&B Rock and Roll” playlist 154 is currently being rendered 352, and the remaining eight tracks of “R&B Rock and Roll” playlist 154 have not yet been rendered 352.

Upon user 20 selecting “Shuffle” button 300, a shuffle command may be received 354 concerning active playlist 56. Playlist shuffling process 10 may generate 356 a non-rendered playlist 58 (FIG. 1). Since the last eight tracks of “R&B Rock and Roll” playlist 154 were not yet rendered, non-rendered playlist 58 may be defined as follows:

| | |
|---|---|
| 16. Respect | Aretha Franklin |
| 17. Johnny B. Goode | Chuck Berry |
| 18. Maybelline | Chuck Berry |
| 19. Tutti Frutti | Little Richard |
| 20. Living In America | James Brown |
| 21. I Got You (I Feel Good) | James Brown |
| 22. What A Price | Fats Domino |
| 23. Blue Monday | Fats Domino |

Depending on whether playlist shuffling process 10 is configured to consider partially-render tracks “rendered”, “Track 15” (i.e., “Don't Know Why” by Norah Jones) of “R&B Rock and Roll” playlist 154 may or may not be included within non-rendered playlist 58. As will be discussed below in greater detail, non-rendered playlist 58 may define one or more non-rendered media tracks (e.g., “Respect” by Aretha Franklin) included within active playlist 56, but may exclude one or more rendered media tracks (e.g., “Brown Eyed Girl” by Van Morrison) included within active playlist 56.

Once non-rendered playlist 58 is generated 356, playlist shuffling process 10 may define 358 a rendering sequence for non-rendered playlist 58.

When generating 356 non-rendered playlist 58, playlist shuffling process 10 may identify 360 the rendered tracks included within active playlist 56 and may identify 362 the non-rendered tracks included within active playlist 56. Assuming for this example that partially-rendered tracks are considered by playlist shuffling process 10 to be “rendered” tracks, the “rendered tracks” identified 360 by playlist shuffling process 10 may include “Brown Eyed Girl”, “Moondance”, “And It Stoned Me”, “Domino”, “I Got A Woman”, “Let the Good Times Roll”, “What'd I Say Parts I & II”, “Great Balls Of Fire”, “Whole Lotta Shakin' Goin' On”, “Unchained Melody”, “You've Lost That Lovin' Feeling”, “Where The Streets Have No Name”, “I Still Haven't Found What I'm Lookin For”, “In God's Country”, and “Don't Know Why”. Further, the “non-rendered tracks” identified 362 by playlist shuffling process 10 may include “Respect”, “Johnny B. Goode”, “Maybelline”, “Tutti Frutti”, “Living In America”, “I Got You (I Feel Good)”, “What A Price” and “Blue Monday”.

When generating 356 non-rendered playlist 58, playlist shuffling process 10 may compare 364 the rendered tracks included within active playlist 56 to the non-rendered tracks included within active playlist 56 to determine if any common tracks exist. If common tracks do exist, playlist shuffling process 10 may remove 366 the common tracks from the identified 362 non-rendered tracks included within active playlist 56. For example, assume that in addition to rendering the twenty-three tracks included within “R&B Rock and Roll” playlist 154, user 20 (who is a big Van Morrison fan) selects the track “Brown Eyed Girl” for rendering a second time. Accordingly, the second instance of “Brown Eyed Girl” would be placed at the end of active playlist 56 (i.e., as the twenty-fourth track). Therefore, with respect to active playlist 56, the non-rendered tracks included within active playlist 56 may be defined as follows:

| | |
|---|---|
| 16. Respect | Aretha Franklin |
| 17. Johnny B. Goode | Chuck Berry |
| 18. Maybelline | Chuck Berry |
| 19. Tutti Frutti | Little Richard |
| 20. Living In America | James Brown |
| 21. I Got You (I Feel Good) | James Brown |
| 22. What A Price | Fats Domino |
| 23. Blue Monday | Fats Domino |
| 24. Brown Eyed Girl | Van Morrison |

As “Brown Eyed Girl” was “Track 1” of “R&B Rock and Roll” playlist 154, “Brown Eyed Girl” was already rendered. Accordingly, when playlist shuffling process 10 compares 364 the rendered tracks included within active playlist 56 (i.e., which includes “Brown Eyed Girl”) with the non-rendered tracks included within active playlist 56 (i.e., which also includes “Brown Eyed Girl”) to determine if any common tracks exist, a common track would be identified (namely “Brown Eyed Girl”). Therefore, playlist shuffling process 10 may remove 366 “Brown Eyed Girl” from the identified 362 non-rendered tracks included within active playlist 56. Therefore, with respect to active playlist 56, the non-rendered tracks included within active playlist 56 may be defined as follows:

| | |
|---|---|
| 16. Respect | Aretha Franklin |
| 17. Johnny B. Goode | Chuck Berry |
| 18. Maybelline | Chuck Berry |
| 19. Tutti Frutti | Little Richard |
| 20. Living In America | James Brown |
| 21. I Got You (I Feel Good) | James Brown |
| 22. What A Price | Fats Domino |
| 23. Blue Monday | Fats Domino |

When defining 358 a rendering sequence for non-rendered playlist 58, playlist shuffling process 10 may define 358 the rendering sequence one track at a time (as will be discussed below in greater detail) or may define 358 the rendering sequence for all (or a portion thereof) of non-rendered playlist 58.

If playlist shuffling process 10 defines 358 the rendering sequence one track at a time, playlist shuffling process 10 may randomly select 368 a first track for rendering from non-rendered playlist 58 and may render 370 the first track selected. Playlist shuffling process 10 may then remove 371 the first track from non-rendered playlist 58 (thus modifying non-rendered playlist 58). Once the first track is rendered 370, playlist shuffling process 10 may determine 372 if additional tracks within non-rendered playlist 58 need to be rendered. If so, the selection process 368, rendering process 370, and removal process 371 may be repeated until all tracks included within non-rendered playlist 58 are rendered once.

For example, playlist shuffling process 10 may randomly select 368 “Johnny B. Goode” for rendering from non-rendered playlist 58. Once “Johnny B. Goode” is rendered 370, playlist shuffling process 10 may modify non-rendered playlist 58 to remove 371 “Johnny B. Goode” and may determine 372 if additional tracks (within non-rendered playlist 58) need to be rendered. Playlist shuffling process 10 may then randomly select 368 (from the remaining tracks defined within non-rendered playlist 58) the track “What A Price” for rendering 370. Once “What A Price” is rendered 370, playlist shuffling process 10 may modify non-rendered playlist 58 to remove 371 “What A Price” and may determine 372 if additional tracks (within non-rendered playlist 58) need to be rendered. Playlist shuffling process 10 may then randomly select 368 (from the remaining tracks defined within non-rendered playlist 58) the track “Tutti Fruitti” for rendering 370. This selection process 368, rendering process 370 and removal process 371, which may be repeated until all tracks included within non-rendered playlist 58 are rendered once, may result in a rendering sequence defined as follows:

| | |
|---|---|
| 1. Johnny B. Goode | Chuck Berry |
| 2. What A Price | Fats Domino |
| 3. Tutti Frutti | Little Richard |
| 4. Maybelline | Chuck Berry |
| 5. Living In America | James Brown |
| 6. Respect | Aretha Franklin |
| 7. Blue Monday | Fats Domino |
| 8. I Got You (I Feel Good) | James Brown |

As discussed above, when defining 358 a rendering sequence for non-rendered playlist 58, playlist shuffling process 10 may define 358 the rendering sequence one track at a time or may define 358 the rendering sequence for all (or a portion thereof) of non-rendered playlist 58. If playlist shuffling process 10 defines 358 the rendering sequence for all (or a portion thereof) of non-rendered playlist 58, playlist shuffling process 10 may define 374 non-rendered track rendering sequence 60 (FIG. 1) for all or a portion of the non-rendered tracks defined within non-rendered playlist 58. The tracks defined within non-rendered track rendering sequence 60 may then be rendered 376 in accordance with non-rendered track rendering sequence 60. For example, when defining 358 the rendering sequence, playlist shuffling process 10 may define 374 non-rendered track rendered sequence 60 as follows: “Johnny B. Goode”, “What A Price”, “Tutti Frutti”, “Maybelline”, “Living In America”, “Respect”, “Blue Monday” and “I Got You (I Feel Good)”. Once defined 374, playlist shuffling process 10 may render 376 the individual tracks defined within non-rendered playlist 58 in accordance with non-rendered track rendering sequence 60.

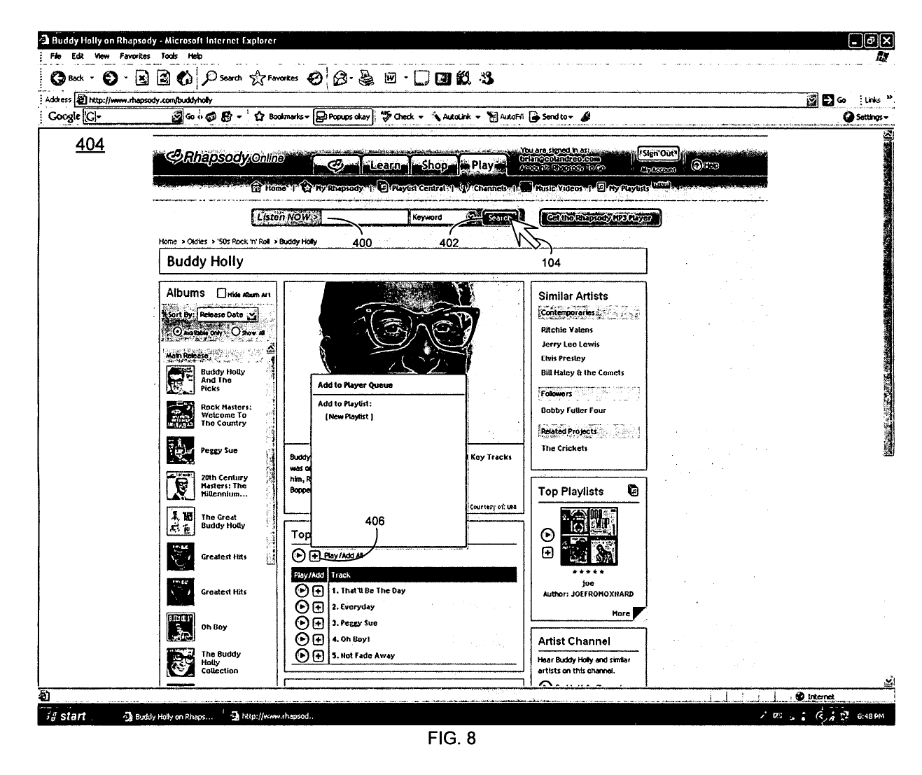

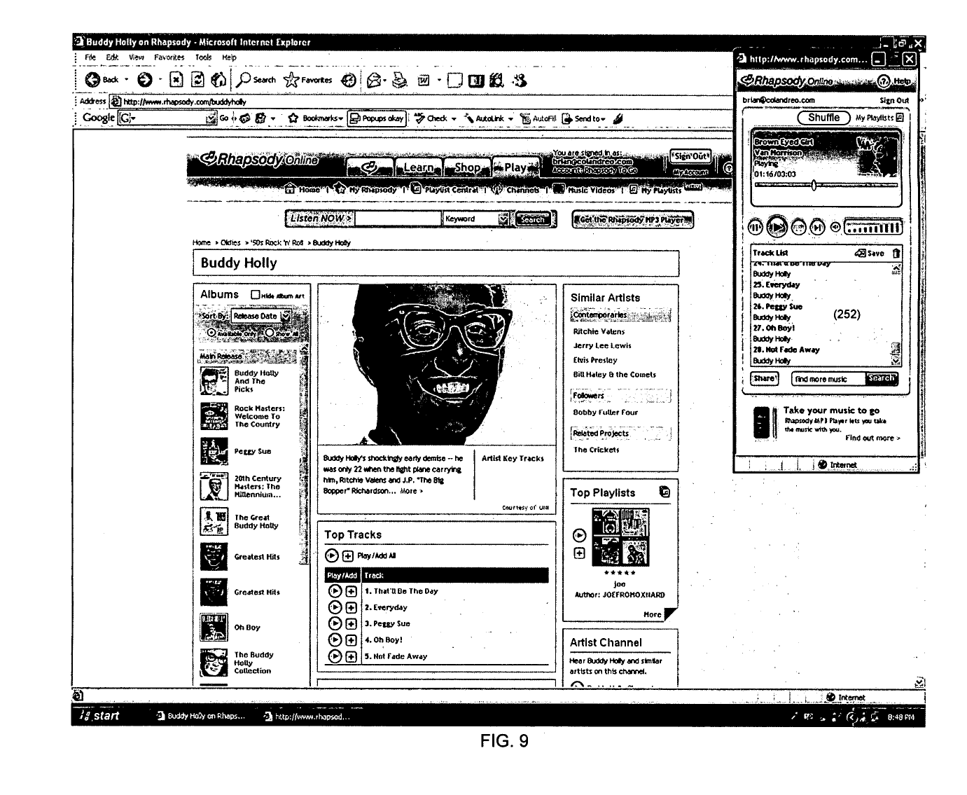

Referring also to FIG. 8, after playlist shuffling process 10 shuffles the non-rendered portion of the active playlist 56, user 20 may wish to listen to additional tracks. Accordingly, if 378 user 20 wishes to listen to additional tracks, user 20 may define one or more supplemental tracks for adding to non-rendered playlist 58. For example, assuming that user 20 wishes to add tracks from “Buddy Holly”, user 20 may enter the appropriate search terms into search field 400 and select (using onscreen pointer 104) “search” button 402. Media distribution system 50 may render web page 404 that provides information on “Buddy Holly”. User 20 may then select one or more tracks for adding to non-rendered playlist 58. For example, by selecting “Add All” button 406, the top five tracks of “Buddy Holly” may be added to non-rendered playlist 58. Accordingly and referring also to FIG. 9, the active playlist 56 defined within active playlist window 252 may be updated to define the five newly-added tracks from e.g., “Buddy Holly” (namely Tracks 24-28).

When adding one or more supplemental tracks to non-rendered playlist 58, playlist shuffling process 10 may compare 380 the tracks being added to the tracks defined in non-rendered playlist 58 to identify common tracks. If common tracks exist, playlist shuffling process 10 may remove 382 the common tracks from the supplemental tracks being added, thus defining one or more non-common supplemental tracks that may be added 384 to non-rendered playlist 58.

In this particular example, none of the five “Buddy Holly” tracks added to non-rendered playlist 58 were previously rendered, as none of them were included within “R&B Rock and Roll” playlist 154. Accordingly playlist shuffling process 10 would not find any common tracks. However, in the event that one or more of the five “Buddy Holly” tracks being added was indeed previously-rendered, playlist shuffling process 10 may compare 380 the supplemental tracks to the non-rendered tracks and determine that the previously-rendered “Buddy Holly” track is a common track. The common “Buddy Holly” track may then be removed 382 from the supplemental tracks prior to adding 384 the remaining supplemental tracks (i.e., the non-common supplemental tracks) to non-rendered playlist 58.

When adding 384 the non-common supplemental tracks to non-rendered playlist 58, playlist shuffling process 10 may simply add the non-common supplemental tracks in a linear fashion to the end of non-rendered playlist 58 for linear sequential rendering. Alternatively, once the non-common supplemental tracks are added, non-rendered playlist 58 may be reshuffled in one of the manners discussed above (e.g., defining 358 the rendering sequence one track at a time or defining 358 the rendering sequence for all (or a portion thereof) of non-rendered playlist 58)

While playlist shuffling process 10 is described above as being resident on and executed by data server 10, this is for illustrative purposes only and is not intended to be a limitation of this disclosure. For example, playlist shuffling process 10 may be resident on and executed by a client electronic device, examples of which may include but are not limited to client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown). Additionally / alternatively, playlist shuffling process 10 may be partially executed on data server 12 and partially executed on a client electronic device.

A number of implementations have been described. Nevertheless, it will be understood that various modifications may be made. Accordingly, other implementations are within the scope of the following claims.

What is Claimed is:

1. A method comprising:
defining an active playlist of media tracks for rendering in a defined sequence;
rendering a portion of the media tracks defined in the active playlist;
receiving a shuffle command from a user concerning the active playlist;
generating a non-rendered playlist, wherein the non-rendered playlist defines one or more non-rendered media tracks included within the active playlist and excludes one or more rendered media tracks included within the active playlist; and
defining a rendering sequence for the non-rendered playlist.

2. The method of claim 1 wherein generating a non-rendered playlist includes:
identifying one or more rendered tracks included within the active playlist;
and
identifying one or more non-rendered tracks included within the active playlist.

3. The method of claim 2 wherein generating a non-rendered playlist includes:
comparing the one or more rendered tracks included within the active playlist to the one or more non-rendered tracks included within the active playlist to identify one or more common tracks; and
removing the one or more common tracks from the one or more non- rendered tracks included within the active playlist, thus defining the non-rendered playlist.

4. The method of claim 2 wherein defining a rendering sequence for the non-rendered playlist includes:
selecting a first track for rendering from the non-rendered playlist;
rendering the first track;
removing the first track from the non-rendered playlist, thus defining a modified non-rendered playlist; and
selecting a second track for rendering from the modified non-rendered playlist.

5. The method of claim 2 wherein defining a rendering sequence for the non-rendered playlist includes:
defining a non-rendered track rendering sequence for two or more of the non-rendered tracks defined within the non-rendered playlist; and
rendering the two or more non-rendered tracks in accordance with the non-rendered track rendering sequence.

6. The method of claim 2 further comprising:
defining one or more supplemental tracks for adding to the non-rendered playlist.

7. The method of claim 6 further comprising:
comparing the one or more supplemental tracks to the one or more non-rendered tracks defined within the non-rendered playlist to identify one or more common tracks;
removing the one or more common tracks from the one or more supplemental tracks, thus defining one or more non-common supplemental tracks.

8. The method of claim 7 further comprising:
adding the one or more non-common supplemental tracks to the non-rendered playlist.

9. The method of claim 7 wherein the method is executed, at least in part, on a server computer.

10. The method of claim 1 wherein the method is executed, at least in part, on a client electronic device.

11. A computer program product residing on a computer readable medium having a plurality of instructions stored thereon which, when executed by a processor, cause the processor to perform operations comprising:
defining an active playlist of media tracks for rendering in a defined sequence;
rendering a portion of the media tracks defined in the active playlist;
receiving a shuffle command from a user concerning the active playlist;
generating a non-rendered playlist, wherein the non-rendered playlist defines one or more non-rendered media tracks included within the active playlist and excludes one or more rendered media tracks included within the active playlist; and
defining a rendering sequence for the non-rendered playlist.

12. The computer program product of claim 11 wherein the instructions for generating a non-rendered playlist include instructions for:
identifying one or more rendered tracks included within the active playlist;
and
identifying one or more non-rendered tracks included within the active playlist.

13. The computer program product of claim 12 wherein the instructions for generating a non-rendered playlist include instructions for:
comparing the one or more rendered tracks included within the active playlist to the one or more non-rendered tracks included within the active playlist to identify one or more common tracks; and
removing the one or more common tracks from the one or more non-rendered tracks included within the active playlist, thus defining the non-rendered playlist.

14. The computer program product of claim 12 wherein the instructions for defining a rendering sequence for the non-rendered playlist include instructions for:
selecting a first track for rendering from the non-rendered playlist;
rendering the first track;
removing the first track from the non-rendered playlist, thus defining a modified non-rendered playlist; and
selecting a second track for rendering from the modified non-rendered playlist.

15. The computer program product of claim 12 wherein the instructions for defining a rendering sequence for the non-rendered playlist include instructions for:
defining a non-rendered track rendering sequence for two or more of the non-rendered tracks defined within the non-rendered playlist; and
rendering the two or more non-rendered tracks in accordance with the non-rendered track rendering sequence.

16. The computer program product of claim 12 further comprising instructions for:
defining one or more supplemental tracks for adding to the non-rendered playlist.

17. The computer program product of claim 16 further comprising instructions for:
comparing the one or more supplemental tracks to the one or more non-rendered tracks defined within the non-rendered playlist to identify one or more common tracks;
removing the one or more common tracks from the one or more supplemental tracks, thus defining one or more non-common supplemental tracks.

18. The computer program product of claim 17 further comprising instructions for:
adding the one or more non-common supplemental tracks to the non-rendered playlist.

19. The computer program product of claim 17 wherein the computer program product is executed, at least in part, on a server computer.

20. The computer program product of claim 11 wherein the computer program product is executed, at least in part, on a client electronic device.
